(19) United States
(12) Patent Application Publication
(10) Pub. No.: US 2008/0124497 A1
(43) Pub. Date: May 29, 2008

(54) Pattern with color varying function

(76) Inventor: Min-San Huang, Taipei County (TW)

Correspondence Address: BACON & THOMAS, PLLC, 625 SLATERS LANE, FOURTH FLOOR, ALEXANDRIA, VA, 22314, US

(21) Appl. No.: 11/605,251

(22) Filed: Nov. 29, 2006

(51) Int. Cl. B44F 1/00

(52) U.S. Cl. 428/29

(57) ABSTRACT

A pattern with a color varying function includes a number of picture units attached on a surface of a carrier. Each of the picture units includes a colorized design displaying directly or indirectly on the surface of the carrier and a transparent spherical grain covering the colorized design. The transparent spherical grain is configured for refracting the colorized design so as to produce various visual effects observing from different viewing angles or changing position angles of the carrier.

### BACKGROUND OF THE INVENTION

1. Field of the Invention

The present invention relates to patterns used in carriers, such as various clothes or home fabrics, and particularly to a pattern with a color varying function observing from different viewing angles or changing position angles of the carriers.

2. Description of the Related Art

Many clothes or home fabrics have various accessorizing designs. A conventional method is attaching patterns thereon. Patterns can be attached on a cloth by various processing methods, such as embroidering or transferring, etc, to present a particular design style for satisfying various needs of consumers.

To highlight visual effects of the patterns, colors, materials and processing manners of the patterns are all important factors which can affect the visual effects. Therefore, many fabricants take efforts to study the visual effects of the patterns, and new designs of the patterns continually emerge.

However, patterns attached on clothes are static state designs, so that styles and colors of the patterns only have differences in shapes observing from different viewing angles. Therefore, the patterns themselves still show similar, single, stiff impressions to observers.

What is needed is to provide a pattern which can give a lively impression to observers.

### BRIEF SUMMARY

A pattern with a color varying function is provided. The pattern includes a plurality of picture units attached on a surface of a carrier. Each picture unit includes a colorized design displaying directly or indirectly on the surface of the carrier and a transparent spherical grain covering the colorized design. The transparent spherical grain is configured for refracting the colorized design so as to produce various visual effects observing from different viewing angles or changing position angles of the carrier.

Because the transparent spherical grain is configured for refracting the colorized design so as to produce various visual effects observing from different viewing angles or changing position angles of the carrier, the colorized design observed through the transparent spherical grain will show various visual effects of color changing when changing the viewing angles or changing position angles of the pattern. Accordingly, the pattern will give a lively impression in vision.

Other objects, advantages and novel features of the invention will become more apparent from the following detailed description when taken in conjunction with the accompanying drawings, in which:

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a pattern with a color varying function in accordance with a preferred embodiment of the present invention; and

FIG. 2 is a front view of the pattern of FIG. 1;

FIG. 3 is an enlarged side view of the pattern attached on a clothes;

FIG. 4 is an enlarged top view of a picture unit of the pattern;

FIG. 5 is an enlarged, exploded view of the picture unit of the pattern, as shown in FIG. 4;

FIG. 6 is an observing view of the picture unit of FIG. 4 from another viewing angle; and

FIG. 7 is an observing view of the picture unit of FIG. 4 from still another viewing angle.

### DETAILED DESCRIPTION

Reference will now be made to the drawings to describe a preferred embodiment of the present pattern with a color varying function, in detail.

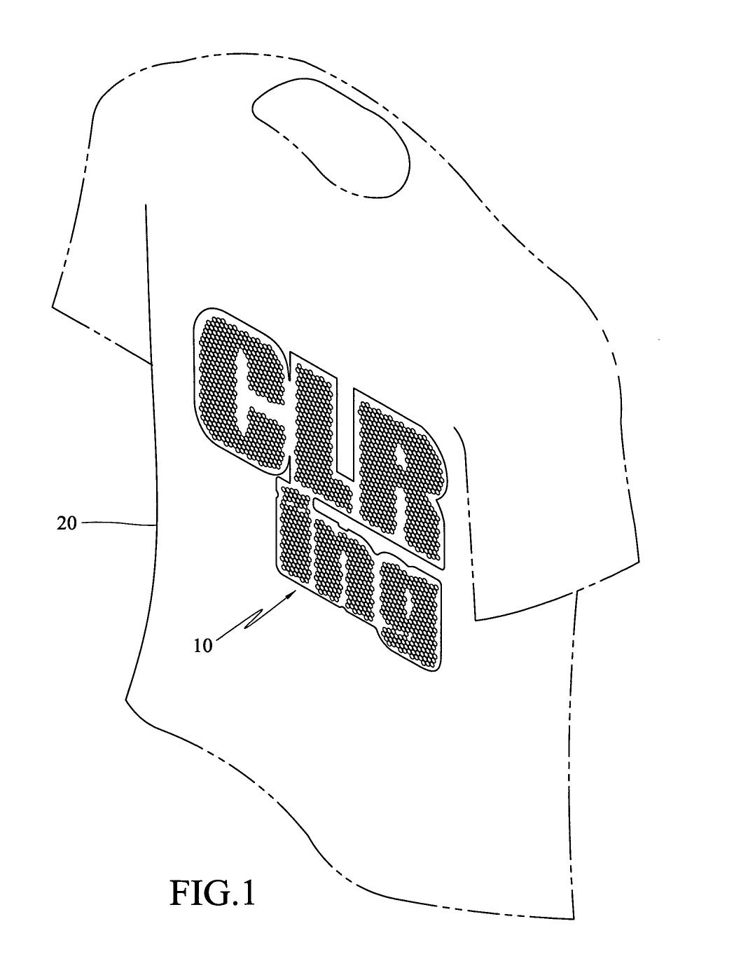

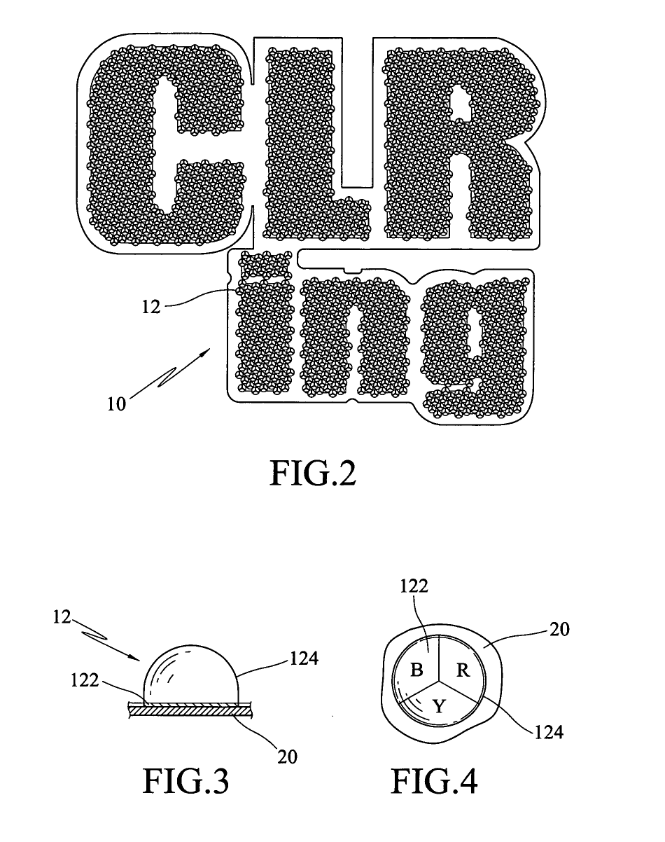

Referring to FIGS. 1 and 2, a pattern 10 with a color varying function in accordance with a preferred embodiment of the present invention is shown. The pattern 10 displaying on a clothing 20 is formed according to a style and a size of a designed picture. The pattern 10 includes a lot of picture units 12 attached on the clothing 20. The picture units 12 may have a same size, and also may have different sizes, which is determined by the designed picture.

In this embodiment, the clothing 20 is used as a carrier for forming the pattern 10. The pattern 10 also can be used on various carriers, such as clothing, trousers, packs, etc, and various home fabrics, such as curtains, step mats, etc. The pattern 10 also can be used on a surface of the carrier which can attach the pattern 10 thereon.

Referring to FIG. 2, the pattern 10 attached on the clothing 20, includes the picture units 12 by being assembled or arranged. Referring to FIG. 3, each of the picture units 12 includes a colorized design 122 displaying on a surface of the clothing 20 and a transparent spherical grain 124 covering on the colorized design 122. The colorized design 122 is covered under the transparent spherical grain 124. The transparent spherical grain 124 is made of a transparent macromolecule material, such as transparent rubber, plastic, glass, etc. Since the transparent spherical grain 124 is made of a transparent macromolecule material, the colorized design 122 can be observed through the transparent spherical grain 124.

The colorized design 122 displaying on the surface of the clothing 20 is a color circle having a number of different color blocks. Referring to FIG. 4, the colorized design 122 is a color circle having yellow (Y), red (R) and blue (B) blocks. The color circle may include two kinds of color blocks, or more than three kinds of color blocks. In addition, the color circle may include gradually changed color blocks.

Furthermore, the transparent spherical grain 124 covering on the colorized design 122 is a sphere or a column having an arc top. Therefore, the colorized design 122 displays through refracted by the transparent spherical grain 124 to obtain a refracting effect.

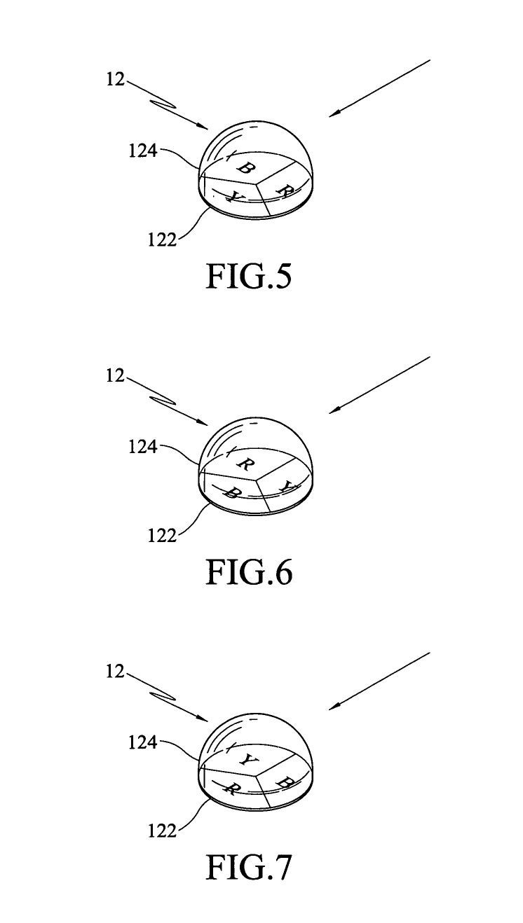

Referring to FIG. 4, the colorized design 122 attached on the surface of the clothing 20 has a yellow block (Y), a red block (R) and a blue block (B). The yellow block, the red block, and the blue block occupy a same region, respectively. (That is, Y obtains 33.3%, R obtains 33.3%, and B obtains 33.3%.) When the colorized design 122 is observed from an exact over direction, an observer will observe three different color blocks with the same region. However, when the colorized design 122 is observed from another viewing angle described as an arrowhead shown in FIG. 5, the observer will observe three different color blocks with different regions since the refracting effect of the transparent spherical grain 124 and the viewing angle changing.

For example, when the colorized design 122 is observed from the viewing angle described as the arrowhead shown in FIG. 5, a visual region of the yellow color block will be increased, and visual regions of the red and blue color blocks will be decreased. Furthermore, visual regions of the three color blocks will change observing from declining angles with a same viewing angle.

When the colorized design 122 is observed from another viewing angle described as an arrowhead shown in FIG. 6, a visual region of the blue color block will be increased, and visual regions of the red and yellow color blocks will be decreased. When the colorized design 122 is observed from still another viewing angle described as an arrowhead shown in FIG. 7, a visual region of the red color block will be increased, and visual regions of the blue and yellow color blocks will be decreased.

From the above, when the pattern 10 attached on the surface of the clothing is observed from different viewing angles as shown in FIGS. 5, 6 and 7, visual regions of the color blocks of the colorized design 122 will change with changing of the viewing angle. Therefore, the colorized design 122 observed through the transparent spherical grain 124 will show various visual effects of color changing when changing the viewing angles or changing position angles of the pattern 10, so the pattern 10 will give a lively impression in vision.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A pattern with a color varying function, the pattern including a plurality of picture units displaying on a surface of a carrier, each picture unit comprising:
a colorized design displaying on the surface of the carrier; and
a transparent spherical grain covering on the colorized design, the transparent spherical grain being configured for refracting the colorized design so as to produce various visual effects observing from different viewing angles or changing position angles of the carrier.

2. The pattern with the color varying function as claimed in claim 1, wherein the colorized design is a color circle including a plurality of different color blocks.

3. The pattern with the color varying function as claimed in claim 2, wherein the color blocks of the color circle have a same region, respectively.

4. The pattern with the color varying function as claimed in claim 1, wherein the colorized design is a color circle including gradually changing colors.

5. The pattern with the color varying function as claimed in claim 1, wherein the colorized design displaying on the surface of the carrier, includes color pigments attached on the surface of the carrier.

6. The pattern with the color varying function as claimed in claim 1, wherein the colorized design displaying on the surface of the carrier, displays on a covering attached on the surface of the carrier.

7. The pattern with the color varying function as claimed in claim 1, wherein the transparent spherical grain is one of a sphere and a column having an arc top.

8. The pattern with the color varying function as claimed in claim 1, wherein the transparent spherical grain is made of a transparent macromolecule material.
